(19) United States
(12) Patent Application Publication
(10) Pub. No.: US 2020/0041723 A1
(43) Pub. Date: Feb. 6, 2020

(54) OPTICAL COUPLING DEVICE AND METHOD FOR PRODUCING SAME

(71) Applicant: TDK Corporation, Chuo-ku, Tokyo (JP)

(72) Inventors: Motohiro NAKAHARA, Mito-shi, Ibaraki (JP); Tetsuo MIYA, Mito-shi, Ibaraki (JP)

(21) Appl. No.: 16/480,287

(22) PCT Filed: Jan. 12, 2018
(86) PCT No.: PCT/JP2018/000616

§ 371 Date: Jul. 23, 2019

(30) Foreign Application Priority Data
Jan. 24, 2017 (JP) 2017-010179

(51) Int. Cl. G02B 6/26; G02B 6/255

(52) U.S. Cl. CPC G02B 6/262; G02B 6/2551

(57) ABSTRACT

A device that enables highly efficient optical coupling between an end face of an optical circuit and an optical fiber without using a V-groove substrate. An optical coupling device that includes an optical fiber, a high NA optical waveguide, a mode field conversion portion having a mode field diameter larger than that of an opposite end of the high NA optical waveguide, and a capillary having a through-hole for holding the high NA optical waveguide and the mode field conversion portion, wherein the opposite end of the high NA optical waveguide is placed in the end portion of the through-hole.

### BACKGROUND

### 1. Field of the Disclosure

This disclosure relates to an optical coupling device and a method for producing the same.

### 2. Discussion of the Background Art

An optical coupling device for connecting an optical element array and an optical fiber has been proposed (for example, see Patent Literature 1). The optical coupling device of Patent Literature 1 has a short-length fiber interposed between an end face of an optical circuit and the optical fiber for highly effective optical coupling.

In the optical coupling device of Patent Literature 1, physical contact connection is performed for making surface contact between cores of the optical fiber and the short-length fiber without a gap. In this case, in order to align optical axes of the optical fiber and the short-length fiber, the optical coupling device of Patent Literature 1 has a micro capillary fixed on a V-groove substrate.

### CITATION LIST

### Patent Literature

Patent Literature 1: JP 2000-121871 A

### SUMMARY

### Technical Problem

In order to miniaturize an optical module or reduce the number of components thereof, it is desirable to omit the V-groove substrate. Meanwhile, highly efficient optical coupling is demanded between the end face of the optical circuit and the optical fiber.

In this regard, an object of this disclosure is to allow highly efficient optical coupling between the end face of the optical circuit and the optical fiber without using the V-groove substrate.

### Solution to Problem

According to this disclosure, there is provided an optical coupling device including: an optical fiber; a high NA optical waveguide having a numerical aperture larger than that of the optical fiber; a mode field conversion portion that has a mode field diameter larger than that of an opposite end of the high NA optical waveguide to couple the optical fiber and the high NA optical waveguide; and a capillary having a through-hole that holds the high NA optical waveguide and the mode field conversion portion, the through-hole having an end portion where the opposite end of the high NA optical waveguide is placed.

According to this disclosure, there is provided a method of producing an optical coupling device, including, in the following order: a fusion bonding process of heating and fusing a connecting portion between an optical fiber and a high NA optical waveguide having a numerical aperture larger than that of the optical fiber, and then pulling the optical fiber and the high NA optical waveguide to directions separating them from each other; a placing process of inserting an opposite end of the high NA optical waveguide from an opening having a larger inner diameter out of two openings of a through-hole of a capillary and placing the high NA optical waveguide and the connecting portion inside the through-hole such that the connecting portion is placed inside the through-hole and that the opposite end of the high NA optical waveguide is placed in an end portion of the through-hole; and a fixing process of fixing the connecting portion inside the through-hole using an adhesive.

### Advantageous Effects of the Disclosure

According to this disclosure, it is possible to enable highly efficient optical coupling between the optical circuit and the optical fiber without using a V-groove substrate.

### BRIEF DESCRIPTION OF DRAWINGS

FIG. 1 illustrates an exemplary configuration of an optical coupling device according to a first embodiment.

FIG. 2 is an explanatory diagram illustrating a placing process.

FIG. 3 is an enlarged view illustrating a mode field conversion portion according to the first embodiment.

FIG. 4 illustrates another type of the optical coupling device according to the first embodiment.

FIG. 5 illustrates exemplary coupling to an optical circuit.

FIG. 6 illustrates an exemplary configuration of an optical coupling device according to a second embodiment.

FIG. 7 illustrates an exemplary configuration of the optical coupling device according to the second embodiment.

### DETAILED DESCRIPTION OF THE PREFERRED EMBODIMENT

Embodiments of this disclosure will now be described in details with reference to the accompanying drawings. Note that this disclosure is not limited to the following embodiments. Such embodiments are merely for exemplary purposes, and this disclosure may be embodied in various changed or modified forms on the basis of understandings of those ordinarily skilled in the art. Note that like reference numerals denote like elements throughout the descriptions and the drawings herein.

### First Embodiment

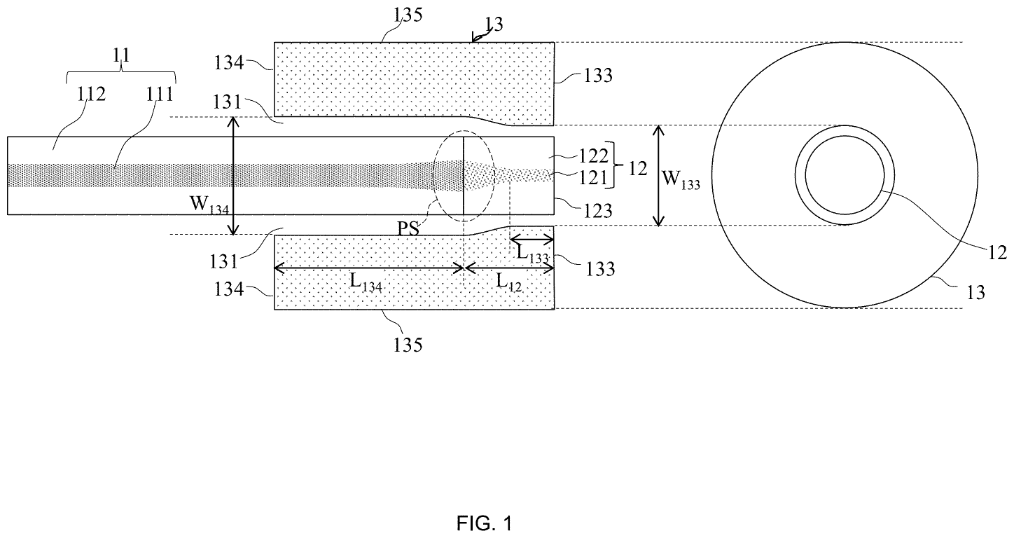

FIG. 1 illustrates an exemplary configuration of an optical coupling device according to this disclosure. The optical coupling device according to this disclosure includes an optical fiber 11, a high NA fiber 12 functioning as a high NA optical waveguide, a mode field conversion portion PS, and a capillary 13. In this embodiment, it is assumed that the optical fiber 11 and the high NA fiber 12 are formed of silica glass.

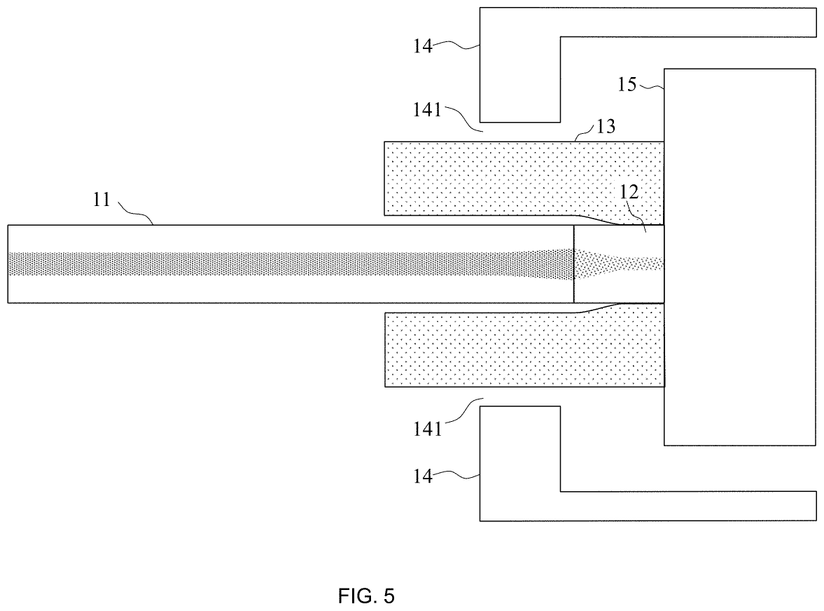

The high NA fiber 12 is an optical fiber having a numerical aperture (NA) higher than that of the optical fiber 11. An end portion 123 being an opposite end of the high NA fiber 12 is connected to an optical circuit (indicated by reference numeral 15 in FIG. 5 as described below). By interposing the high NA fiber 12 between the optical fiber 11 and the optical circuit, it is possible to couple the light from the optical fiber 11 to the optical circuit with little loss. It is preferable to apply 8° polishing or anti-reflection coating to the end portion 123 of the high NA fiber 12 in order to avoid reflection on the end portion 123.

The high NA fiber 12 contains an impurity including at least a type of material for improving a refractive index, such as tantalum (Ta), germanium (Ge), titanium (Ti), and zirconium (Zr). Since Ta, Ti, and Zr increase the refractive index even with a small amount of addition, it is possible to further reduce a mode field diameter of the high NA fiber 12 in the end portion 123 by adding at least any one of Ta, Ti, or Zr. In addition, in order to suppress an increase of distortion due to an increased thermal expansion coefficient caused by the additive, the high NA fiber 12 may contain at least a type of material having a negative thermal expansion coefficient, such as tin (Sn) or hafnium (Hf).

Although the optical fiber 11 and the high NA fiber 12 may be combined arbitrarily, it is preferable that the mode field diameter of the high NA fiber 12 substantially matches the mode field diameter of the optical circuit 15. For example, in a case where a single mode fiber having a mode field diameter of 10 μm is employed and the optical circuit (reference numeral 15 in FIG. 5 as described below) has a mode field diameter of 3.2 μm, a high NA single mode fiber having a mode field diameter of 3.2 μm may be employed as the high NA fiber 12.

The NA of the optical fiber 11 and the high NA fiber 12 are not particularly limited, and for example, if the NA of the optical fiber 11 is 0.13, the NA of the high NA fiber 12 is set to an arbitrary value of 0.41 to 0.72. Note that the optical fiber 11 and the high NA fiber 12 may be either single mode fibers or multi-mode fibers. In addition, the optical fiber 11 and the high NA fiber 12 may have the same cladding diameter or different cladding diameters.

The mode field conversion portion PS is a portion where one end of the high NA fiber 12 and the optical fiber 11 are connected, and has a mode field diameter larger than that of the opposite end of the high NA fiber 12. The mode field conversion portion PS preferably has the equal mode field diameter in the connecting portion between the optical fiber 11 and the high NA fiber 12, the mode field diameter may be set to be a mode field diameter between that of the optical fiber 11 and that of the opposite end of the high NA fiber 12, and the mode field diameter is preferably set to be equal to that of the optical fiber 11 or larger than that of the optical fiber 11.

The mode field conversion portion PS is preferably formed by fusion-bonding the optical fiber 11 and the high NA fiber 12 with a uniform mode field diameter. By performing the fusion bonding, the impurity added to the core is diffused due to local heating, so that the core expands in a bell-shaped distribution. For this reason, the mode field diameter of the mode field conversion portion PS becomes larger than that of the opposite end of the high NA fiber 12, so that it is possible to connect the optical fiber 11 and the high NA fiber 12, that is, different types of fibers, with little loss and to widen an allowable range of decentering.

The capillary 13 has a through-hole, and the mode field conversion portion PS is placed inside the through-hole. The capillary 13 preferably holds the entire high NA fiber 12. In this case, the end portion 123 of the high NA fiber 12 and an end portion 133 of the capillary 13 are preferably arranged on the same plane. As a result, it is possible to facilitate alignment when the optical coupling device according to this disclosure is connected to the optical circuit.

An inner diameter W₁₃₃ in the vicinity of the end portion 123 of the high NA fiber 12 is preferably substantially equal to the cladding diameter of the high NA fiber 12. For example, if the high NA fiber 12 has a cladding diameter of 125 μm, the inner diameter W₁₃₃ is preferably set to: 126≤W₁₃₃≤127 μm.

An inner diameter W₁₃₄ of the mode field conversion portion PS is preferably larger than the inner diameter W₁₃₃ in the vicinity of the end portion 123 of the high NA fiber 12. This is to house the high NA fiber 12 even when the cladding diameter increases in the fusion-bonded portion. For example, if the high NA fiber 12 has a length L₁₂ and the high NA fiber 12 has a cladding diameter of 125 μm, the inner diameter W₁₃₄ at a distance L₁₃₄ from the end portion 134 is preferably set to: 127 μm<W₁₃₄≤152 μm.

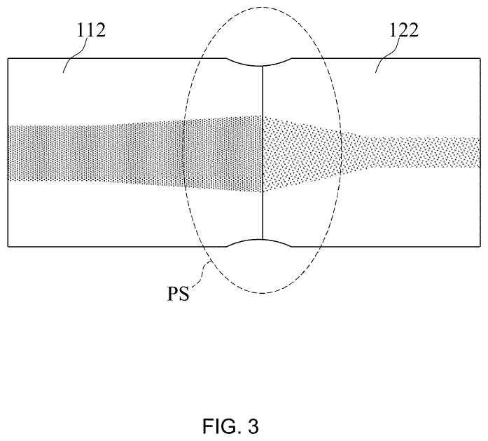

A gap, between an inner wall surface of the through-hole and the optical fiber 11 and the high NA fiber 12, is filled with an adhesive. As a result, it is possible to protect the mode field conversion portion PS using the capillary 13. In this case, the inner diameter of the end portion 134 side is preferably larger than the inner diameter of the end portion 133 side. In particular, although not illustrated in FIG. 1, the inner diameter of the through-hole preferably increases gradually from the mode field conversion portion PS to the end portion 134 side. As a result, it is possible to facilitate filling, with the adhesive, the gap between the inner wall surface of the through-hole of the capillary 13 and the optical fiber 11 and the high NA fiber 12. For example, even when air bubbles are generated in the adhesive filling a recess portion illustrated in FIG. 3, it is possible to easily remove the air bubbles. Furthermore, even when the optical fiber 11 and the high NA fiber 12 have different extending diameters, it is possible to place the mode field conversion portion PS inside the through-hole.

The through-hole having the inner diameters W₁₃₃ and W₁₃₄ may be formed by widening the inner diameter of the through-hole having the inner diameter W₁₃₃. For example, boring using a drill in the through-hole or melting of the inner wall of the through-hole by etching using hydrofluoric acid may employed by way of example. Using a drill, the inner diameter of the through-hole can be trimmed uniformly. Using the etching, the inner diameter of the through-hole can be widened as close to the end portion 134.

A method of producing the optical coupling device will be described. A method of producing the optical coupling device according to this disclosure includes a connecting process, a placing process, and a fixing process in order.

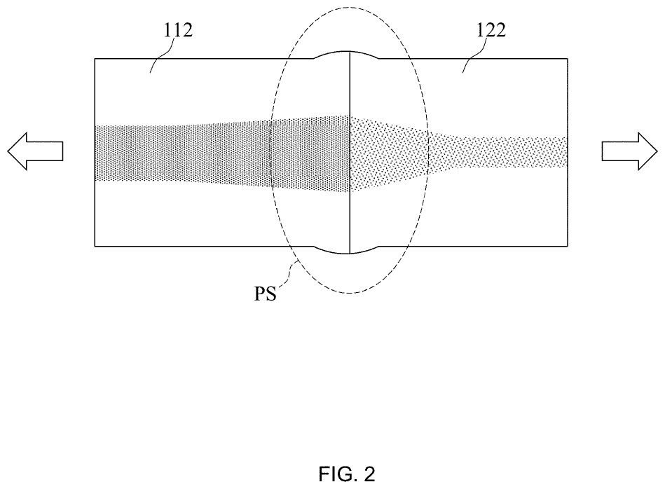

In the connecting process, the optical fiber 11 and the high NA fiber 12 are fusion-bonded. Here, typically, if the fusion bonding is performed, the diameter of the mode field conversion portion PS increases as illustrated in FIG. 2. In this regard, in the connecting process according to this disclosure, it is preferable that the optical fiber 11 and the high NA fiber 12 are heated in the mode field conversion portion PS and, after the optical fiber 11 and the high NA fiber 12 are fused, the optical fiber 11 and the high NA fiber 12 are pulled to directions separating them from each other as illustrated in FIG. 2. As a result, it is possible to prevent increasing of the diameter of the mode field conversion portion PS. In this case, as illustrated in FIG. 3, recesses are formed in the claddings 112 and 122 in the mode field conversion portion PS.

In the placing process, the opened end portion 123 of the high NA fiber 12 is inserted into the opening of the end portion 134 side out of two openings of the through-hole of the capillary 13 to place the mode field conversion portion PS inside the through-hole.

In the fixing process, the mode field conversion portion PS is fixed inside the through-hole using an adhesive. For example, ultraviolet curing resin is injected into the gap 131 of FIG. 1 from the end portion 134 side, and ultraviolet rays are emitted from a side face 135 of the capillary 13. As a result, it is possible to fix the mode field conversion portion PS inside the through-hole.

After the fixing process, the end portion 123 of the high NA fiber 12 is polished to align the length of the end portion 123 of the high NA fiber 12 to the position of the end portion 133 of the capillary 13. In this case, it is preferable to apply 8° polishing or anti-reflection coating to the end portion 123.

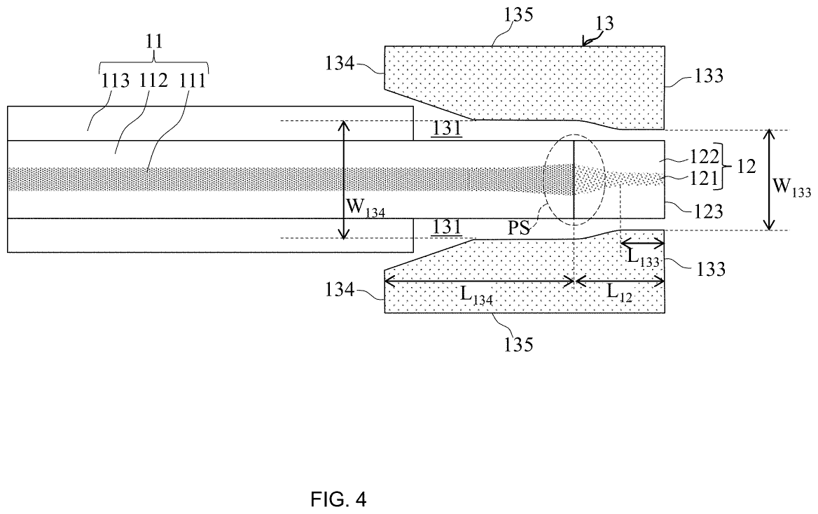

FIG. 4 illustrates another type of the optical coupling device according to this disclosure. In the optical coupling device according to this disclosure, the coating 113 of the optical fiber 11 is placed inside the capillary 13. The capillary 13 is tapered to place the coating 113 inside the through-hole.

In the case of another type of the optical coupling device, in the connecting process, a length of the optical fiber 11 from the coating 113 to the mode field conversion portion PS is set to be shorter than a distance L₁₃₄ from the end portion 134 to the mode field conversion portion PS.

FIG. 5 illustrates exemplary connecting of the optical coupling device according to this disclosure to the optical circuit. The end portion 133 of the capillary 13 is connected to the optical circuit 15. Since the high NA fiber 12 having a small mode field diameter is placed in the end portion 133 of the capillary 13, light from the optical fiber 11 can be easily coupled to the optical waveguide formed of glass. As a result, using the optical coupling device according to this disclosure, it is possible to easily perform highly efficient optical coupling between the optical fiber 11 and the optical waveguide formed of glass without using a V-groove substrate.

The optical circuit 15 is a planar light wave circuit (PLC) chip formed of, for example, silica glass (SiO₂). According to this disclosure, since the mode field diameter is small in the end portion 133 of the capillary 13, a PLC chip provided with an optical waveguide having a specific refractive index difference of 0.3% and a mode field diameter of 10 μm or a small PLC chip provided with an optical waveguide having a specific refractive index difference of 1.2% and a mode field diameter of 2 to 5 μm may be applied to the optical circuit 15.

Without limiting to the PLC chip formed of silica glass (SiO₂), the optical circuit 15 may include a PLC chip formed by using silicon (Si) in the substrate. In addition, without limiting to the PLC chip, the optical circuit 15 may include any optical fiber or any optical element. For example, instead of the optical circuit 15, the optical coupling device may be used for coupling to a light-emitting element such as a semiconductor laser or a photodetector such as photodiode (PD).

The optical fiber 11 is held inside the capillary 13 while the high NA fiber 12 is placed at the end portion 123, and therefore, it is possible to hermetically seal the inside of the casing 14 by hermetically sealing the gap 141 between the casing 14 and the capillary 13. For this reason, it is also possible to use the optical coupling device according to this disclosure to hermetically seal a micro integrated coherent (ICR) or a micro integrable tunable laser assembly (ITLA).

Note that the optical fiber 11 and the high NA fiber 12 may be formed of plastic. In a case where the high NA fiber 12 is a plastic optical fiber, the high NA fiber 12 having a mode field conversion portion PS having a mode field diameter larger than that of the end portion 123 is employed. In addition, in the connecting process, bonding is performed using any adhesive instead of the fusion bonding.

### Second Embodiment

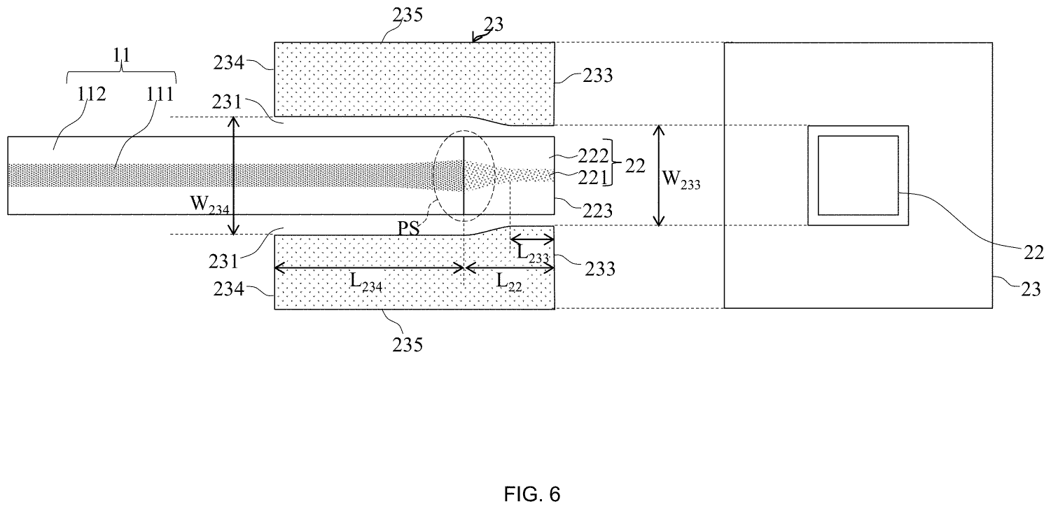

FIG. 6 illustrates an exemplary configuration of an optical coupling device according to this disclosure. The optical coupling device according to this disclosure includes an optical fiber 11, a PLC 22 functioning as a high NA optical waveguide, and a capillary 23.

The NA of the PLC 22 is larger than that of the optical fiber 11. Similar to the high NA fiber 12 illustrated in FIG. 5, an end portion 223 of the PLC 22 is connected to the optical circuit 15. By interposing the PLC 22 between the optical fiber 11 and the optical circuit, it is possible to couple the light from the optical fiber 11 to the optical circuit 15 with little loss. The end portion 223 of the PLC 22 is preferably subjected to 8° polishing or anti-reflection coating in order to avoid reflection on the end portion 223. Differences from the first embodiment will now be described.

The mode field conversion portion PS is a portion where one end of the PLC 22 and the optical fiber 11 are connected and has a mode field diameter larger than that of an opposite end of the PLC 22. The mode field conversion portion PS preferably has the equal mode field diameter in the connecting portion between the optical fiber 11 and the PLC 22, the mode field diameter may be set to a mode field diameter between that of the optical fiber 11 and that of the opposite end of the PLC 22, and the mode field diameter is preferably set to be equal to that of the optical fiber 11 or larger than that of the optical fiber 11. Note that, since the mode field diameter of the PLC 22 depends on a shape of the core, such as a square or rectangular shape, the PLC 22 preferably has a refractive index or a core shape so as to obtain a desired mode field diameter in the mode field conversion portion PS.

The optical fiber 11 and the PLC 22 may be formed of silica glass or plastic. In a case where the optical fiber 11 and the PLC 22 are formed of silica glass, the impurity of the first embodiment may be employed as an impurity of the PLC 22. In addition, the PLC 22 may be formed by laminating silica glass on a silicon (Si) substrate.

In a case where the optical fiber 11 and the PLC 22 are formed of silica glass, similar to the first embodiment, the mode field conversion portion PS may be formed by fusion-bonding the optical fiber 11 and the PLC 22 with a uniform mode field diameter.

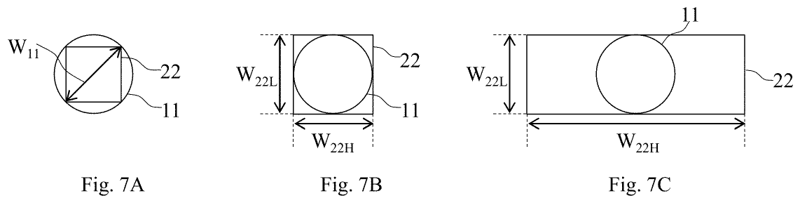

FIG. 7 illustrates exemplary shapes of the optical fiber 11 and the PLC 22. As illustrated in FIG. 7(A), the optical fiber 11 may have a diameter W₁₁ equal to a diagonal length of the PLC 22. In addition, as illustrated in FIGS. 7(B) and 7(C), the optical fiber 11 may have the diameter W₁₁ equal to a height W_{22L} of the PLC 22. As illustrated in FIG. 7(B), the optical fiber 11 may have the diameter W₁₁ equal to a width W_{22H} of the PLC 22. As illustrated in FIG. 7(C), the PLC 22 may have the width W_{22H} larger than the diameter W₁₁ of the optical fiber 11. In addition, the PLC 22 may have a height W_{22L} larger than the diameter W₁₁ of the optical fiber 11. The center of the height W_{22L} of the PLC 22 or the center of the width W_{22H} may not match the center of the optical fiber 11.

Note that, in each of the aforementioned embodiments, the end portion of the high NA fiber 12 or the end portion of the optical circuit 15 side of the PLC 22 may be connected to a polarization-maintaining optical fiber. As a result, it is possible to improve an extinction ratio when the optical fiber 11 and the polarization-maintaining optical fiber are connected.

Although it is assumed in this disclosure that a single optical fiber 11 is provided for easy understanding purposes, this disclosure may also be applied to a multiple channel configuration in which two or more optical fibers 11 are arranged. In this case, the optical fiber 11 and the high NA fiber 12 or the PLC 22 may be arranged one-dimensionally or two-dimensionally.

The capillary 13 or 23 may have any exterior shape without limiting to a circular shape or a rectangular shape. For example, a ferrule may be provided in the outside of the capillary 13 or 23 in order to facilitate connection between the high NA fiber 12 or the PLC 22 and other optical components.

### INDUSTRIAL APPLICABILITY

This disclosure is applicable to an information communication technology industry.

### REFERENCE SIGNS LIST

11 OPTICAL FIBER

111 CORE

112 CLADDING

12 HIGH NA FIBER

22 PLC

121, 221 CORE

122, 222 CLADDING

123 END PORTIONOF HIGH NA FIBER

13 CAPILLARY

131, 231 GAP

133, 134, 233, 234 END PORTION

135, 235 SIDE FACE

14 CASING

141 GAP

15 OPTICAL CIRCUIT

What is claimed is:

1. An optical coupling device comprising:
an optical fiber;
a high NA optical waveguide having a numerical aperture larger than that of the optical fiber;
a mode field conversion portion that has a mode field diameter larger than that of an opposite end of the high NA optical waveguide to couple the optical fiber and the high NA optical waveguide; and
a capillary having a through-hole that holds the high NA optical waveguide and the mode field conversion portion, the through-hole having an end portion where the opposite end of the high NA optical waveguide is placed.

2. The optical coupling device according to claim 1, wherein the high NA optical waveguide is an optical fiber or a planar light wave circuit (PLC) formed of silica glass, and
the high NA optical waveguide has a core formed of at least one element selected from a group consisting of Ta, Ge, Ti, and Zr.

3. The optical coupling device according to claim 2, wherein
the one end of the high NA optical waveguide and the optical fiber are fusion-bonded, and
the one end of the high NA optical waveguide functions as the mode field conversion portion.

4. The optical coupling device according to claim 3, wherein the mode field conversion portion has a recess in a cladding of the high NA optical waveguide.

5. The optical coupling device according to claim 3, wherein the high NA optical waveguide has a core formed of at least one element selected from a group consisting of Sn and Hf.

6. The optical coupling device according to claim 1, wherein the high NA optical waveguide is an optical fiber or a planar light wave circuit (PLC) having a mode field diameter of the one end larger than that of the opposite end,
the one end of the high NA optical waveguide and the optical fiber are bonded, and
the one end of the high NA optical waveguide functions as the mode field conversion portion.

7. The optical coupling device according to claim 1, wherein the through-hole where the mode field conversion portion is placed has an inner diameter larger than that of the through-hole where the opposite end of the high NA optical waveguide is placed.

8. A method of producing an optical coupling device, comprising, in the following order:
a fusion bonding process of heating and fusing a connecting portion between an optical fiber and a high NA optical waveguide having a numerical aperture larger than that of the optical fiber, and then pulling the optical fiber and the high NA optical waveguide to directions separating the optical fiber and the high NA optical waveguide from each other;
a placing process of inserting an opposite end of the high NA optical waveguide from an opening having a larger inner diameter out of two openings of a through-hole of a capillary and placing the high NA optical waveguide and the connecting portion inside the through-hole such that the connecting portion is placed inside the through-hole and that the opposite end of the high NA optical waveguide is placed in an end portion of the through-hole; and
a fixing process of fixing the connecting portion inside the through-hole using an adhesive.

9. The optical coupling device according to claim 4, wherein the high NA optical waveguide has a core formed of at least one element selected from a group consisting of Sn and Hf.

10. The optical coupling device according to claim 2, wherein the high NA optical waveguide is an optical fiber or a planar light wave circuit (PLC) having a mode field diameter of the one end larger than that of the opposite end,
the one end of the high NA optical waveguide and the optical fiber are bonded, and
the one end of the high NA optical waveguide functions as the mode field conversion portion.

11. The optical coupling device according to claim 2, wherein the through-hole where the mode field conversion portion is placed has an inner diameter larger than that of the through-hole where the opposite end of the high NA optical waveguide is placed.

12. The optical coupling device according to claim 3, wherein the through-hole where the mode field conversion portion is placed has an inner diameter larger than that of the through-hole where the opposite end of the high NA optical waveguide is placed.

13. The optical coupling device according to claim 4, wherein the through-hole where the mode field conversion portion is placed has an inner diameter larger than that of the through-hole where the opposite end of the high NA optical waveguide is placed.

14. The optical coupling device according to claim 5, wherein the through-hole where the mode field conversion portion is placed has an inner diameter larger than that of the through-hole where the opposite end of the high NA optical waveguide is placed.

15. The optical coupling device according to claim 6, wherein the through-hole where the mode field conversion portion is placed has an inner diameter larger than that of the through-hole where the opposite end of the high NA optical waveguide is placed.
